(19) United States
(12) Patent Application Publication
(10) Pub. No.: US 2010/0299908 A1
(43) Pub. Date: Dec. 2, 2010

(54) ASSEMBLY AND METHOD FOR MANUFACTURING A HOSE

(75) Inventors: Andreas Hibert, Dueren (DE); Derek Cornils, Merzenich (DE); Thomas Bischof, Aachen (DE)

Correspondence Address: COLLARD & ROE, P.C., 1077 NORTHERN BOULEVARD, ROSLYN, NY, 11576, US

(73) Assignee: Reis GmbH & Co. KG Maschinenfabrik, Obernburg (DE)

(21) Appl. No.: 12/734,803

(22) PCT Filed: Dec. 8, 2008
(86) PCT No.: PCT/IB2008/003426

§ 371 Date: May 25, 2010

(30) Foreign Application Priority Data
Dec. 6, 2007 (DE) 10 2007 059 187.1

(51) Int. Cl. B23P 19/02; B23P 19/04

(52) U.S. Cl. 29/525; 29/282

(57) ABSTRACT

An assembly for manufacturing a hose with a nozzle, which is connected with a hose via an annular outlet and preferably has a perforation inside the annular outlet, the hose having a mount on its end opposing the nozzle and the mount having a perforation. This makes it possible to also lead a cooling medium against the direction of the extrusion through the extruded hose.

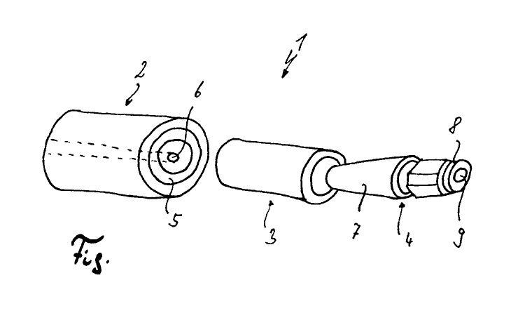

### CROSS REFERENCE TO RELATED APPLICATIONS

This application is the National Stage of PCT/IB2008/003426 filed on Dec. 8, 2008, which claims priority under 35 U.S.C. §119 of German Application No. 10 2007 059 187.1 filed on Dec. 6, 2007. The international application under PCT article 21(2) was not published in English.

The invention relates to an assembly for manufacturing a hose with a nozzle which is connected to a hose via an annular outlet, the hose having a mount at its end opposing the nozzle.

With such assemblies, hoses made of thermoplastic materials are extruded. The annular outlet serves to press the hose material through the nozzle, while a perforation disposed inside the annular outlet serves to convey air into the hose. This air serves as support air to prevent the still soft extruded hose from collapsing.

Such assemblies have proved efficient. The production speed is however limited by the design of the nozzles and the cooling process of the hose.

The object of the invention is therefore to develop a generic assembly in such a manner as to allow a faster production of hoses.

This object is solved by a generic assembly in which the mount has a perforation.

In order to allow the support air that has been pressed into the hose to fulfill its support function, it is at first self-evident that the mount must be closed. A perforation in the mount however allows us to use the mount as air regulator and thus to press a greater volume of air through the hose. The greater volume of air requires a higher pumping capacity, but thanks to the higher volume of air conveyed through the hose, a stronger cooling of the hose is achieved. It thus becomes possible either to produce the hose faster or to a stronger cooling down of the hose during production.

A perforation of the mount further makes it possible to convey air through the perforation of the mount into the hose and preferably even further through a perforation of the nozzle. The fact that the air flow is contrary to the usual method—against the direction of the extrusion—from the end of the hose to the nozzle leads to the cool air entering the hose at the end of the hose and slowly growing warms inside the hose. It is advantageous if the cooling medium leaves the assembly through the nozzle in a heated state. Such a cooling is particularly effective and allows for a best possible cooling of the end of the hose located in the area of the mount.

By dimensioning the perforations at the beginning and at the end of the hose, as well as adjusting the pressure of the cooling air, the hose also can be supported or if necessary even be stretched by the air by means of the assembly of the invention. It is clearly apparent that a higher volume of air is needed because of the perforation of the mount, provided the diameter of the perforation in the nozzle is kept. This higher volume of air leads to a better cooling and thus makes a faster production possible. Depending on the application, the size of the perforation in the nozzle can be varied and in special situations even remain closed.

It is self-evident that the bores are also adapted to lead another cooling medium, as for instance another gas or a fluid, through the hose instead of air, in order to achieve a supporting, a forming or a cooling action, depending on the application.

It is advantageous if the mount is an arbor. An arbor makes a simple connection between the hose and the mount possible and, at the same time, makes it possible to provide a perforation in its core in a simple manner, through which a medium is lead into the hose.

In order to provide for a medium to flow through the hose against the direction of the extrusion, it can be provided that the mount is connected to a pressure device. A compressed air device or another gaseous cooling medium can serve as a pressure device.

The medium conveyed through the hose can exit easily through the nozzle. A particularly good flow through the hose can however be achieved by connecting the nozzle with a suction device.

Particularly good results have been achieved when the pressure device and the suction device are connected to a control unit. It is even more advantageous if the pressure device and the suction device are connected to a regulation device. This makes it possible to precisely regulate the pressure in the hose and to convey a high volume flow through the hose. Since the length of the hose continuously increases during production, a regulation device should be preferred for regulating the pressure in the hose.

An implementation variant provides for the mount to be a plug. Such a plug can be easily connected to a cooling medium supply device. The plug can also be permanently connected to the hose so that, in future use, it can serve to connect the hose to an apparatus.

It is particularly advantageous if this plug is made of a plastic material. This makes a connection between the mount configured as a plug and the die cast plastic hose easier.

It is particularly advantageous if the plug has a coupling. The hose can thus be easily connected to a power unit and any compressed air or cooling medium supply device can be attached to the plug.

The assembly according to the invention is not only adapted for manufacturing simple hoses. With this assembly it is also possible to manufacture hoses from multiple components, if the nozzle is a multi-component nozzle like for instance a two-component nozzle. The manufactured hoses are then composed of different materials that adopt varying functions. An outer layer can for instance bring about a particularly good resistance to pressure and temperature by using polyamide, while an inner layer made of a thermoplastic polymer presents a particular resistance to chemicals. In other applications, the outer layer can be a thermoplastic polymer, while the inner layer has a polyamide.

In practice, such multi-component nozzles are configured in a relatively big manner. This however limits their applicability more specifically when used with robots. It is therefore proposed that the nozzle should have dimensions of about 30×100×100 mm. Such a nozzle is advantageous and essential to the invention in any generic assembly.

Nozzles of such particularly small design, which are more specifically configured as multi-component nozzles, are disposed on the sixth axis of a robot. More specifically a robot with such a nozzle on its sixth axis is new and inventive.

Another embodiment provides for the nozzle to have a core drive. The position of the core in relation to the mantle can thus be positioned in an optimal manner in order to manufacture even complicated hose geometries. Connecting a core drive with a two-component nozzle is also new and inventive and therefore essential to the invention.

A simple use of the assembly provides for the hose to be extruded onto the mount.

The hose hereby preferably has polyamide and TPE. An alternative provides for the hose to have polyamide and polypropylene.

A particular embodiment of the assembly provides for the hose to be disposed in a hull. The hull carries the extruded hose and makes it possible for the hose to calmly cool down. A particular embodiment of the hull, which is also essential to the invention independently from the above-mentioned features of the invention, provides for the material of the hull to absorb a maximum of 50% of the heat emitted every second by the hose. The depositing surface for the hose is therefore a bad heat conductor. While particularly good heat conductors are usually used for manufacturing the hull, the invention relies on the knowledge that a bad heat conductor in the hull makes a particularly homogenous cooling of the hose possible.

In order to give the hose a particular shape, it is proposed that the shape of the hull should be changeable. An oval hose for instance can thus be easily manufactured by using a hull made of two hinged half hulls connected to each other. These half hulls can be moved toward each other, while the hose is solidifying, in order to influence its shape.

For further development it is proposed that the material of the hull should absorb a maximum of 20% of the heat emitted every second by the hose.

The assembly further provides for an overpressure of a maximum of 1 bar, preferably about 0.05 to 0.3 bar in the hose. This overpressure supports the hose during its cooling and makes an advantageous volume flow of a cooling medium through the hose possible.

Air is preferably employed as cooling medium. Various other gases or gas mixtures can however also be employed.

The object of the invention is also solved by a method for manufacturing a hose, in which a hose is extruded from a nozzle. According to the invention, a medium is conveyed into the hose from the end of the hose opposing the nozzle. Thus, a particularly good cooling of the hose is achieved.

In order to make a continuous volume flow inside the hose possible, it is proposed that the medium should exit the hose through a bore in the nozzle.

A constant inner counter pressure is achieved by keeping constant the pressure which is generated by the medium in the hose.

For this, the pressure generated by the medium in the hose can for instance be regulated. Alternatively or cumulatively, the flow of the medium can also be regulated.

The method can be employed particularly advantageously when extruding a multi-component hose.

Automation can also be achieved when the hose is extruded by a nozzle on a robot.

It is hereby more specifically advantageous, if the hose is extruded into a hull.

Extensive test series have shown that it is advantageous if a hole is made in the hose before stripping the hose off the nozzle. This hole is preferably disposed close to the nozzle. A simple conduct of the method hereby provides for a cannula to be thrust into the hose. A volume flow of cooling medium can thus still be conveyed through the hose while stripping off the hose. This makes it possible to maintain an almost constant pressure in the hose and also to keep cooling off the hose, which has been stripped off the nozzle, by means of a cooling medium, which is conveyed through the hose.

A variant of the method provides for the hose to be separated in such a manner that an aperture remains in the hose after separation. For instance, in a separation by means of a scissor, the process can be conducted in such a manner that the hose is not closed completely during separation. This makes it possible for the cooling medium to escape the hose after separation.

A simple implementation variant is described in the FIGURE. The only FIGURE schematically shows an assembly of nozzle, hose and mount.

The shown assembly 1 consists essentially of the nozzle 2, the hose 3 and the mount 4. The nozzle 2 has an extrusion channel 5 and a central bore 6. The hose is shown schematically between the nozzle 2 and the mount 4. In practice, it flows however out of the nozzle 2 and is held by the arbor 7 of the mount 4.

The mount 4 is configured as a plug from a plastic material and has a coupling 8 at its end opposing the hose. The coupling can be configured in one piece with the hose. Alternatively, the coupling is a part of the tools for manufacturing the hose.

After extrusion or during extrusion, the hose 3 is laid into a hull (not shown) in which it cools down.

The hull can be configured in such a manner that by changing the shape of the hull after inlaying the hose, the shape of the hose can be changed. The hull preferably has elements which are movable relative to each other and which can influence the shaping of the hose. That way an—if necessary also only partly—oval hose can be manufactured.

In order to manufacture the hose, a hose is produced by means of the known extrusion nozzle. A particularly small design of the nozzle, attached to the sixth axis of a robot can hereby preferably be used.

The hose is fastened to the arbor 7 of the mount 4 with its end opposing the nozzle and a compressed air device is fastened to the coupling 8. This makes it possible to lead compressed air, through a bore 9 in the mount 4, through the hose 3 and out of the assembly through the bore 6 in the nozzle. Control and regulating devices maintain a constant pressure in the hose even though a greatest possible volume flow of cooling medium is conveyed through the hose.

Before stripping the hose 3 off the nozzle 2, a cannula that can also be connected to a suction device, is stabbed into the hose. That way the flow of the cooling medium through the hose is maintained even after stripping off the hose.

1. An assembly for manufacturing a hose with a nozzle, which is connected to a hose via an annular outlet, the hose having a mount at its end opposing the nozzle, wherein the mount has a perforation.

2. The assembly according to claim 1, wherein the nozzle has a perforation inside the annular outlet.

3. The assembly according to claim 1, wherein the mount is an arbor.

4. The assembly according to claim 1, wherein the mount is connected to a pressure device.

5. The assembly according to claim 1, wherein the nozzle is connected to a suction device.

6. The assembly according to one of the claims 4, wherein the pressure device and the suction device are connected to a control unit.

7. The assembly according to claim 4, wherein the pressure device and the suction device are connected to a regulating device.

8. The assembly according to claim 1, wherein the mount is a plug.

9. The assembly according to claim 8, wherein the plug is made of a plastic material.

10. The assembly according to claim 8, wherein the plug has a coupling.

11. The assembly according to claim 1, wherein the nozzle is a multi-component nozzle.

12. The assembly according to claim 1, wherein the nozzle has dimensions of about 30×100×100 mm.

13. The assembly according to claim 1, wherein the nozzle is disposed on the sixth axis of a robot.

14. The assembly according to claim 1, wherein the nozzle has a core drive.

15. The assembly according to one claim 1, wherein the hose is extruded onto the mount.

16. The assembly according to claim 1, wherein the hose has polyamide and TPE.

17. The assembly according to claim 1 wherein the hose has polyamide and polypropylene.

18. The assembly according to claim 1, wherein the hose is disposed in a hull.

19. The assembly according to claim 18, wherein the shape of the hull is changeable.

20. The assembly according to claim 18, wherein the material of the hull absorbs a maximum of 50% of the heat emitted by the hose every second.

21. The assembly according to claim 18, wherein the material of the hull absorbs a maximum of 20% of the heat emitted by the hose every second.

22. The assembly according to claim 1, wherein there is an overpressure of a maximum of 1 bar, preferably of about 0.5 bar in the hose.

23. A method for manufacturing a hose, in which a hose is extruded from a nozzle, wherein a medium is conveyed into the hose from the end of the hose opposing the nozzle.

24. The method according to claim 23, wherein the medium exits the hose through a bore in the nozzle.

25. The method according to claim 23, wherein the pressure generated by the medium in the hose is maintained constant.

26. The method according to claim 23, wherein the pressure generated by the medium in the hose is regulated.

27. The method according to claim 23, wherein the flow of the medium is regulated.

28. The method according to claim 23, wherein a multi-component hose is extruded.

29. The method according to claim 23, wherein the hose is extruded by a nozzle on a robot.

30. The method according to claim 23, wherein the hose is extruded into a hull.

31. The method according to claim 23, wherein after inlaying the hose, the shape of the hose is changed.

32. The method according to claim 23, wherein before stripping the hose off the nozzle, a hole is made in the hose.

33. The method according to claim 32, wherein the hole is disposed close to the nozzle.

34. The method according to claim 23, wherein a cannula is thrust into the hose.

35. The method according to claim 23, wherein the hose is separated in such a manner that an aperture remains in the hose after separation.
